(19) United States
(12) Patent Application Publication
(10) Pub. No.: US 2026/0280754 A1
(43) Pub. Date: Sep. 17, 2026

(54) HARDWARE-BASED SECURING OF DATA TRANSMISSION IN AUTOMOBILES FOR TRANSMITTING DATA OVER MULTIPLE CHANNELS

(71) Applicant: INOVA SEMICONDUCTORS GMBH, Munich (DE)

(72) Inventors: Roland NEUMANN, Bad Toelz (DE); Fabian KLUGE, Perasdorf (DE)

(73) Assignee: INOVA SEMICONDUCTORS GMBH, Munich (DE)

(21) Appl. No.: 19/680,443

(22) Filed: May 18, 2026

Related U.S. Application Data
(63) Continuation of application No. PCT/EP2024/076655, filed on Sep. 23, 2024.

(30) Foreign Application Priority Data
Nov. 21, 2023 (EP) 23211223.5

(51) Int. Cl. H04L 1/00

(52) U.S. Cl. CPC H04L 1/0042

(57) ABSTRACT

A system arrangement generates substitute data which can be used if transmitted data is recognised as erroneous. Separate physical channels are provided and data is replicated at a suitable location, transmitted redundantly and coded accordingly. Various security mechanisms are integrated and synergistically linked to ensure secure data transmission in an automobile. Separate physical channels make it possible for data to be transmitted redundantly according to a scheme proposed whereby interactions between the transmission media are prevented. The coding makes it possible for the receiver to recognise an error. If this is recognised, the redundantly transmitted data can be used on the receiver side and the data transmission as a whole is not impaired. Also provided is a corresponding method which enables the system arrangement to be provided or operated.

### CROSS REFERENCE TO RELATED APPLICATIONS

This application is a continuation of International Application No. PCT/EP2024/076655, filed on September 23, 2024, which takes priority from European Application No. 23211223.5 filed on November 21, 2023 the entire contents of each of which are incorporated by reference herein.

### TECHNICAL FIELD

The present invention is directed to a system arrangement which generates substitute data which can be used if transmitted data is negatively verified, i.e. if it is recognised as faulty. Separate physical channels are provided and data is replicated at a particularly suitable location, transmitted redundantly and coded accordingly. In the special combination of features, various security mechanisms are integrated and synergistically linked in such a way that particularly secure data transmission in the automobile is guaranteed. Embodiments of the present invention specifically addresses the security requirements and hardware conditions in the vehicle, which is not the case with packet-switched communication, for example. Separate physical channels make it possible for data to be transmitted redundantly according to the scheme proposed, whereby interactions between the transmission media are prevented. The coding makes it possible for the receiver to recognise that there may be an error with regard to data integrity or that data has been transmitted incorrectly or not at all. If this is recognised, the redundantly transmitted data can be used on the receiver side and the data transmission as a whole is not impaired. The present disclosure is also directed to an appropriately configured method which enables the system arrangement to be provided or operated. In addition, a computer program product is proposed with control commands that execute the method or provide or operate the system arrangement.

### BACKGROUND

US 2010/0138573 A1 describes a transmission system with multiple parallel paths, in which data is divided into segments, distributed across different paths, and recombined at the receiving end. Control commands are duplicated and evaluated using majority voting to increase robustness.

US 2009/0034633 A1 discloses a method comprising a primary data stream and a parallel redundancy data stream, in which selected frames are transmitted redundantly so that the redundancy stream can be used in the event of errors in the primary stream.

US 5,995,518 A discloses a communication system in which information is distributed across channels with different latencies, such that time-critical content is transmitted via a fast channel and additional content via a slower, high-bandwidth channel to reduce perceived delays.

US 2014/0029611 A1 discloses a system for sharing a serial communication port across multiple logical channels, wherein a multiplexer and identification information are used to route the data streams of multiple channels via a common physical interface.

Typically, there is no packet-switched transmission of data in cars; instead, components are hard-wired or hard-coded and therefore there is no dynamic switching of packets or sequential or serial data communication can be carried out. Particularly strict requirements apply to data integrity in automobiles and it must be ensured at all times that transmitted data is also received completely and correctly on the receiver side. Safety functions are typically implemented in cars, which must be particularly fail-safe and reliable. Another requirement in cars is to minimise technical complexity and save weight. In electromobility in particular, an increased energy requirement has an impact on the range, which must be avoided at all costs. Furthermore, conventional packet-switched transmission technologies cannot be used in cars as they often do not meet latency requirements or too much effort is required for dynamic and packet-switched transmission. The effort involved includes providing components that select a dynamic data path, which is not necessary in cars.

The state of the art recognises a layer model as a hierarchical organisational structure. It is used to divide complex systems into manageable layers or levels, with each layer having specific tasks and responsibilities. These layers work together to enable the overall functionality of the system. A state-of-the-art example of a layered model is the OSI (Open Systems Interconnection) model used in packet-switched network technology. It consists of seven layers, with each layer performing specific tasks related to communication between computers and devices. The layers range from the physical connection layer to the application layer, with each layer building on the services of the layer below.

It is known from the state of the art to transmit data that is potentially transmitted incorrectly redundantly. These redundancies also create replacement data, whereby the prior art has the negative effect that the data may already be corrupted before replication. In this way, replacement data is created that is redundant but still contains errors. The disadvantage of this is that a great deal of technical effort is required to replicate the data and a corresponding network load is created without this providing any added value. As a result, conventional methods do not focus on the underlying architecture or the application domain and it is wrongly assumed that correct data is available, although the redundant data also contains errors. In this way, a supposedly reliable procedure is created in the state of the art, which nevertheless continues to deliver incorrect data.

Data integrity generally refers to the accuracy, reliability and consistency of data in an information system or database. It ensures that data remains correct during storage, transmission and processing and is not inadvertently or maliciously altered. Ensuring data integrity is critical to ensure that information is trustworthy and useful, especially in safety-critical applications such as automotive.

Furthermore, so-called forward error correction is known from the state of the art. Forward Error Correction (FEC) is a method of error correction in which additional redundancy information is added to the data. This redundancy enables the receiver to recognise and correct errors without having to resend the packet. FEC is often used in high-speed Ethernet connections such as 10 Gigabit Ethernet (10GbE) to ensure data integrity.

Error correction mechanisms play a crucial role in ensuring reliable data transmission in networks. They help to detect, isolate and correct transmission errors to ensure that data integrity is maintained. Especially in business-critical environments where large amounts of data are transmitted, error correction mechanisms are essential to maintain the quality of the connection.

Furthermore, it is generally known from the state of the art that data transmission via a serial data channel is typically subject to errors. To counter this problem, the state of the art recognises different encodings, such as line coding. This is also known as line coding.

The state of the art recognises the problem of faulty data transmission via a serial communication link and provides for the line-coded data to be provided with a forward error correction. The state of the art therefore addresses the problem of error correction by providing line-coded data with a non-line-coded addition, namely forward error correction, which in turn is not line-coded. This means that in the state of the art there is the problem that even if line coding is provided, individual metadata is not transmitted in coded form and therefore the advantages of line coding cannot be utilised for all transmitted data. This in turn represents a source of error. The state of the art sometimes makes do by encoding the forward error correction data separately and then transmitting it. This results in additional work and a new forward error correction would have to be calculated in order to secure the line-coded forward error correction data. This in turn creates additional effort and also creates a non-line-coded forward error correction.

In general, the prior art has the problem that it is not sufficiently analysed at which point in a system arrangement or at which position in a process data can be replicated particularly advantageously and can be transmitted particularly advantageously. This means that the state of the art does not provide any reliable methods to ensure that data integrity is guaranteed, even in the case of redundant data transmission.

Another disadvantage of the prior art is that a great deal of technical effort is required to replicate and transmit the data. A method or system arrangement that works particularly efficiently or at hardware level is desirable here.

In addition, prior art methods that transmit packet-based data are not applicable, as they are based on completely different network architectures that must ensure dynamic packet switching. This means that prior art methods are created that require other security mechanisms, such as sequential or serial data transmission.

It is therefore a task of the present invention to provide a system arrangement for providing substitute data specifically in an automobile. The system arrangement should be designed to be particularly efficient and yet robust against errors. It is also a task of the present invention to provide a correspondingly configured method or a computer program product with control commands which implement the method or provide or operate the system arrangement.

### SUMMARY

Accordingly, a system arrangement for securing a data transmission is proposed, comprising a transmission device set up for redundant encoding of first data units into a first instance of the first data units and a second identical and thus redundant instance of the first data units, and furthermore set up for encoding second data units, whereby a forward error correction is added in each case for all encodings; and exactly two physical, separate data transmission media which communicatively couple the transmitting device and a receiving device, wherein the transmitting device is set up to transmit the first instance of the first data units exclusively via one data transmission medium and to transmit the second instance of the first data units exclusively via the respective other data transmission medium and furthermore to transmit the second encoded data units to the receiving device via an optional one of the two data transmission media.

In the present case, the data transmission is secured by a combination of several mechanisms that interact synergistically. The data to be transmitted is provided with a forward error correction, which enables the receiver to determine whether the data has been received correctly or the forward error correction allows the receiver to correct the data. In the event of negative verification of data, replacement data is used, which is also provided with a forward error correction. In this way, the integrity of this data can also be checked and if the first data cannot be used, this replacement data is used. Furthermore, it is particularly advantageous according to embodiments of the invention that the first data is sent via a first transmission medium and the second data is sent via a second, different communication medium. This ensures that the data is always available at the same time, which distinguishes the present invention from a packet-switched approach, and also ensures that a correct and functional transmission channel is selected.

If the data is received incorrectly on the receiver side and cannot be corrected by means of the forward error correction, this may be due to various steps in the transmission process, whereby embodiments of the invention ensure that in the event of a defective transmission medium, the further data is provided via another, separate transmission medium. In this way, errors are avoided which do not only relate to the processing of the data, but in particular it is also ensured that at least one functional transmission medium is available. The process only terminates if both transmission media are faulty. However, this case is atypical and typically only temporary failures or impairments of the transmission medium occur. This ensures that in the event of an error, which is actually recognised due to the forward error correction, a redundant transmission channel is available to transmit replacement data.

In accordance with embodiments of the invention, multiple protection is therefore proposed, whereby the data is encoded redundantly and the individual security mechanisms work together synergistically in such a way that the forward error correction can also be used to select a redundant transmission channel or a redundant transmission medium. So if the receiver recognises that the first data is incorrect, the second data transmission medium ensures that replacement data is available, which can then also be verified using the forward error correction. The combination of these features creates the advantage over the prior art that a robust method or a robust system arrangement is created, which can be provided with little technical effort. In addition, the present invention offers the possibility of implementing the security mechanisms on a purely hardware-based basis. For example, the data can be replicated in such a way that there is an interconnection on the transmitter side that automatically duplicates or replicates the data, and this can be done particularly advantageously simply by interconnecting input interfaces to output interfaces. It is thus possible for the output interfaces to be present in greater numbers than the input interfaces. In this way, it is not necessary to replicate the data by means of calculation steps, but rather this mechanism can be interconnected on the hardware side and is therefore particularly error-resistant and fail-safe.

According to embodiments of the invention, a transmission device is provided which receives first data units and second data units and forwards them. For this purpose, the first transmission data is replicated in such a way that a first instance of these data units is created and a second, identical instance of these first data units is created. The second data units are data units that are not to be transmitted redundantly. Thus, according to the invention, a distinction can be made between particularly security-critical data units, namely the first data units, and data units with a normal security requirement. These can then be forwarded without replication, i.e. non-redundantly.

The data units themselves can be forwarded or encoded and, in particular, can be divided into any number of segments. These can be individual cells. A forward error correction is calculated for the data units, which enables the recipient of the data to use this forward error correction to check the correctness of the received data and correct it if necessary. The forward error correction can therefore relate to the data units themselves or to individual segments. If the data units are segmented, each segment can receive a forward error correction. The data units can also have frame data, such as header data, which stores the calculated forward error correction. In this way, a corresponding format can be specified.

The separate data transmission media can be a contact or a cable. The transmission medium can therefore be electrical, optical or a waveguide. Separate data transmission media are generally media that do not influence each other. It is therefore advantageous to shield the corresponding transmission media electromagnetically and/or to ensure that the second medium is still functional if a first medium fails. This means that the separate transmission media should not be present as a single contact or a single cable. This is not contradicted by the fact that both transmission media are arranged on a common circuit board, for example. This means that the separate transmission media as such are not virtual paths on the same transmission medium. However, it is generally possible to operate virtual paths on each of the transmission media.

In order to ensure that the receiver device receives the data correctly even in the event of a failure or impairment of a channel, the first instance of the first data units is sent via a communication medium and the second instance, i.e. the same redundant data, is sent via a second communication medium. On the receiver side, the enclosed forward error correction code can be used to recognise whether the data can be transmitted correctly. If this is not the case, this may be due to faulty data processing or the transmission channels are impaired. According to embodiments of the invention, it is possible that the error does not need to be searched for further, but that it is recognised. Consequently, the receiver device attempts to repair the received data units by means of the transmitted forward error correction code, which is often not possible. This is due to the natural limits of forward error correction. Although forward error correction can generally repair minor errors, for example individual bit errors, this is not possible to an unlimited extent. If this is not possible, it is particularly advantageous that the redundant data, i.e. the second instance, can be transmitted via the second data transmission channel. This is done in any case, as it is particularly preferable to use serial or sequential communication, i.e. not packet-based communication. It is advantageous here that the first instance and the second instance of the data units are transmitted at the same time if possible, so that it is ensured that the second instance of the data units is already present when the first instance of the data units is discarded.

It is now also possible to check the second instance of the data units using the forward error correction code and, in the event of a negative verification, i.e. if the data transmission is incorrect, the second instance can be corrected using the forward error correction code. This means that if the first instance of the data units is transmitted incorrectly, it is possible to check the second instance and correct it if necessary. The two communication channels therefore work together synergistically with the respective forward error corrections. If the correction of the first instance fails, it is still possible to check and, if necessary, repair the second instance, which was transmitted via the second channel. If the transmission of the first instance fails, the second instance can be used as replacement data. The first instance is thus discarded and processing of the second instance continues without delay.

The second encoded data units are optionally transmitted to the receiving device via one of the two data transmission media. It is therefore possible for any data transmission medium to be selected or for the second data units to be divided into segments and for the segments to be sent via one or the other data transmission segment as required. Thus, for example, the second data units are transmitted via a first communication path and as soon as further second data units are available, these are transmitted via the second communication path. Thus, according to the invention, it is possible to transmit the second data units via optionally one data transmission medium irrespective of where the data units of the first data units are transmitted. In this way, load balancing can take place in such a way that the more favourable transmission medium is always selected. One metric for selecting the data transmission medium can be that, for example, latency times or bandwidth availability are checked and then the second data units are sent via the data transmission medium that currently has favourable parameters. If, for example, it is recognised that the first data units are always transmitted incorrectly via a certain transmission medium, the other data transmission medium can be selected for the second data units. The selection is not static in this case, but the selection can also change dynamically at runtime for the second data units.

According to one aspect of the present invention, the system arrangement is set up for load balancing with respect to bandwidths and/or latency specifications of the two data transmission media. This has the advantage that the respective advantageous data transmission medium can be selected for the transmission of the respective data. Since the parameters can also change during runtime, optional selection also means that the data units can also be sent via the other data transmission medium during runtime. This applies in particular to the second data units, which can be sent via the first or the second channel.

According to a further aspect of the present invention, the transmission of the encoded data units via the data transmission media is sequential. This has the advantage that efficient and fast data transmission is ensured and that no further logic or intermediate components need to be implemented, as is the case with packet-switched transmission. According to one aspect of the present invention, sequential can also mean serial. This therefore means that the data is connected in series and is not packetised in such a way that one packet could overtake another. For example, the data segments or data units can also be numbered consecutively and always arrive in the intended order.

According to a further aspect of the present invention, the receiving unit is set up to check and/or correct the correctness of the first instance and/or the second instance of the data units using the forward error correction. This has the advantage that errors themselves can be recognised and, in addition, an error can be corrected according to the forward error correction. Checking the forward error correction of the second instance of the data units is typically only necessary if the verification of the first data units has failed. It can then be checked whether the second instance was transmitted correctly, whether it can be corrected if necessary, and whether it can still be used to replace the first data units in the first instance.

According to a further aspect of the present invention, the receiving unit is set up to take into account the second instance of the data units if the first instance of the data units is not transmitted correctly. This has the advantage that valid data units are always present and the first data units can then be discarded. Due to a possible serial or sequential transmission, it is possible that the second instance of the data units is available in the receiver at the same time as the first instance of data units. In this way, it is possible to replace data from the first instance with data from the second instance in real time and there is no delay.

According to a further aspect of the present invention, the receiving unit is configured to take into account the second instance of the data units when the first instance of the data units is not transmitted. This has the advantage that data units which were transmitted via a different data line can be taken into account and thus a potential error or impairment in the first data transmission medium is avoided. Even if the first data transmission medium is damaged or does not function as specified, the second transmission medium is very likely to be functional. According to the invention, it is also possible for a first instance of data units to be sent via a first data channel or via a first transmission medium and a second instance via the second transmission medium, with the other channel being selected for a further first instance of the data units and thus the first channel also being selected for the further second instance of data units. It is therefore possible to switch dynamically between the individual data units at runtime. For example, if there are five first instances of the first data units and therefore also five instances of the second data units, the first instance can be transmitted via one of the data transmission media in each case. The channel or transmission medium can be changed for the next instance of the data units. This means that the first instances and second instances are sent alternately via the transmission media and it is therefore possible to check which channel or which data transmission medium is working according to specification. If, for example, there are five instances of the first data units, these can be sent alternately below and above with reference to the figures described in the illustration. The same therefore also applies to the further instances of the redundant data, which can also be sent alternately via the first or the second channel.

According to a further aspect of the present invention, the data units are divided into cells and a forward error correction is appended to each cell. This has the advantage that the data units as a whole do not have to be provided with a forward error correction, but rather they can be subdivided and the subdivisions each receive a forward error correction. This makes it possible to introduce fine-grained forward error corrections and thus also increases the possibility of correcting errors . This is the case because the forward error corrections then only relate to smaller segments of the data units and therefore only smaller signal sequences or bit sequences need to be protected.

According to a further aspect of the present invention, the coding comprises line coding. This has the advantage that very robust signal sequences are created, which also guarantee stable data transmission. A further security mechanism is therefore used, which can be advantageously integrated into the existing combination of features. For example, it is possible according to the invention for the data units to be broken down into smaller words and for lines to be encoded in a particularly advantageous way. Line coding is also described as line coding and is to be used synonymously here.

According to a further aspect of the present invention, data transmission can be carried out via virtual paths. This has the advantage that a plurality of virtual paths can be operated on the physical transmission media, which can be operated independently of one another, but within the limits of the physical data path. Thus, for example, it is possible to transmit the first data units with the second data units on the same physical level, i.e. the same physical transmission medium, whereby a first virtual path is provided for the first data units on the one physical communication path and another virtual path is provided for the second data units on the same physical transmission medium.

According to a further aspect of the present invention, the data transmission media are each cable-bound. This has the advantage that transmission channels are created which can be separated particularly easily, i.e. the first data transmission medium does not influence the second data transmission medium. For this purpose, it may be necessary to provide electromagnetic shielding, for example. This ensures that the first data units and the second data units are really transmitted separately from each other, i.e. without interaction.

According to a further aspect of the present invention, a specification of transmission parameters together with their tolerance ranges of all data units is realised cumulatively in the two data transmission media. This has the advantage that the system arrangement as a whole must be subject to a certain required performance according to a specification and therefore it must be ensured for the transmission media which characteristics or parameters these have. For example, certain latency times or a certain bandwidth may be required, which must be provided by the system arrangement as a whole, i.e. cumulatively.

According to a further aspect of the present invention, the data transmission media each support 15 gigabits per second. This has the advantage that sufficient bandwidth is available and thus 30 gigabits per second of data can be transmitted in their entirety. Empirical research has shown that this is particularly advantageous in cars. Of course, faster data lines can also be provided, but this would involve greater technical effort.

According to embodiments of the invention, substitute data is generated on the transmitter side and is used to utilise transmitted data in the event of faulty transmission or coding errors. Replacement data is therefore the data that is used if transmitted data cannot be received correctly by the recipient. The recipient can verify the data received, i.e. check that it is correct, and the replacement data can be used in the event of a negative verification or check. This means that the substitute data is not only used to check the correctness of the actual data, but also, in addition or alternatively, to check it by means of a forward error correction. In the event that the actual data was transmitted correctly, the substitute data can be discarded. If the forward error correction results in a positive verification or a positive check, the replacement data is deleted or no longer taken into account.

Due to the serial data transmission, it is not possible, according to one aspect of the present invention, for individual data packets to overtake others. This can occur, for example, during packet-orientated transmission, and data is sent again, for example, when a predefined time period expires. Thus, according to the invention, it is not necessary to add further information about the sequence of the data packets. Serial data transmission takes place via a wired medium, for example electrically or via optical fibre.

The proposed invention is therefore particularly favoured for use in automobiles, as the fastest possible and yet error-free transmission of data is required here. In accordance with the invention, it is possible to provide the proposed system arrangement in one piece, i.e. all components are hard-wired to each other and cannot be separated non-destructively. This represents an advantage over the prior art and means that known methods of packet-switched transmission or Internet technology cannot be used.

The system arrangement has a physical application device that receives data from signal sources at application level. Such a signal source can be, for example, an imaging device that is connected to the application device via HDMI and/or display port in accordance with one aspect of the present invention. The application device can therefore have several inputs or interfaces. Potentially safety-critical data is provided here, which must be transmitted securely to a receiver.

According to one aspect of the present invention, the application data is packaged in cells according to a predefined cell format. This means that the data can be recoded or the data remains unchanged and only additional information is appended. For example, the data format or the cell format can provide for header data to be added to the data, for example describing a virtual path. Even if the proposed system arrangement is hard-wired, it is still possible for the existing data paths to be switched dynamically, for which purpose a path table must be provided. However, the order of the devices passing through is always the same. Only different virtual paths can be addressed on the existing physical paths without having to change the order of the devices in the flow diagram.

According to embodiments of the invention, different input interfaces are provided in the application device. For example, a first port serves as an input interface and a second port also serves as an input interface. It is possible for the first input interfaces to provide particularly safety-critical information, which is then passed on to a large number of output interfaces. Within the application device, the data that is received at the input interface is replicated and output at the output interfaces in multiples of the number of input interfaces.

The multiple in the number in relation to the number of input interfaces and output interfaces therefore refers to a factor in relation to which the number of output interfaces is available in relation to the number of input interfaces. If, for example, one input interface is provided, a multiple of this can be that two or, in another example, three output interfaces are available. If there are two input interfaces, this can be three or six output interfaces in one example. This ensures that the number of data is replicated in the same ratio as the output interfaces. The multiple must be interpreted in such a way that at least two can be considered a multiple. This does not necessarily have to be an integer multiple. For example, a number of two input interfaces can also lead to three output interfaces. The typical case here is that there is one input interface and two output interfaces. The minimum factor of two therefore refers to the number of one input interface. However, if there are two input interfaces, a factor of 1.5 can also apply. The only important thing here is that the number of input interfaces does not correspond to the number of output interfaces and that, logically, only whole numbers of input interfaces and output interfaces are present.

The application device therefore receives data packets or application data and this data is implicitly replicated by the number of output interfaces. This ensures the efficient generation of redundant replacement data without the need for a large amount of computing power. The hardware interconnection of the application device alone ensures that the data is forwarded redundantly. This circuit is therefore particularly robust and less prone to errors, as no separate logic needs to be implemented.

The data is output redundantly to a cell demultiplexing device, which then receives the packaged or encoded data. This device has the same number of receiving interfaces as the application device has output interfaces. Communication between these two devices can take place via a communication medium such as a data line or at least one contact. This data channel can also be designed in such a way that virtual communication paths can also be set up on it.

In addition, further application data is received via a second number of input interfaces of the application device. This data may be data that is not safety-critical and therefore does not need to be transmitted redundantly. This data can also be encoded according to the cell format and a forward error correction can also be added to this data. This data is simply passed through the application device and is not forwarded redundantly. There is therefore an equal number of output interfaces for these input interfaces. This can be one interface or, for example, two, three or four interfaces. This data is also output to the cell multiplexing device, but this is done without replication.

In general, the application data can be changed or processed in the application device. This data is therefore still referred to as application data and is encoded in cells according to the specified cell format. Furthermore, it is also possible for additional data to be added to the application data, which is not just framework data, such as header data, but rather additional user data can also be added to this application data. This means that they are still available as application data, but have been edited and/or expanded or reduced.

According to the invention, it is particularly advantageous that the replication of the data takes place between the application device and the cell multiplexing device. Thus, according to embodiments of the invention, it has been recognised that replication of the data must take place particularly early in the processing chain, since the data is highly likely to still be unaltered here. This creates the advantage over the prior art that unnecessary intermediate processing steps are not carried out and the data is only saved or replicated afterwards. embodiments of the proposed invention are based on a three-layer model and not on conventional seven-layer models. Conventional layer models are therefore not used, in particular because these layer models are used in packet-switched data transmission. Thus, while the prior art generally recognises the replication of data, embodiments of the invention synergistically combine replication with error correction and the special position within the devices creates the special technical effect that the system arrangement as a whole is very error-resistant, since the data is replicated right at the start of the processing procedure.

According to one aspect of the present invention, the output interfaces and/or the input interfaces are each present as physical interfaces. This has the advantage that the input interfaces can be realised as conventional ports and the physical configuration of input interfaces and output interfaces makes it possible for the application data to be replicated without computer-implemented or dynamic logic. It is therefore not necessary to provide a processor that replicates the data, but rather the application device can be interconnected in such a way that it replicates the data based on the interconnection alone. This creates an error-resistant approach that does not allow the data to be falsified. There are also advantages in terms of processing time and the technical effort required to provide the proposed system arrangement.

According to one way of the present invention, the application data is sent from the application device to the cell multiplexing device and/or from the cell multiplexing device to a data transmission device by means of virtual communication paths. This has the advantage that the physical communication channels can be optimally utilised and various virtual channels can be set up via a single physical channel and these can also be controlled separately. This makes it possible for the virtual paths to be optimised in terms of bandwidth utilisation, for example. In addition, the proposed system arrangement is particularly hardware efficient, as it is not necessary to create a separate physical channel for each channel.

According to a further aspect of the present invention, the cell format provides frame data and/or at least one source identifier of a virtual path for data transmission. This has the advantage that it is possible to specify in the cell format via which virtual channel data is sent, which can be done, for example, using a channel identifier. Additionally or alternatively, it is also possible for a source identifier to be specified, which therefore specifies the interface from which the data originates and therefore it is possible to trace which data was originally involved. It is also possible for the source identifier to define an interface and thus specify which path is to be selected from the source. The paths can also be virtual channels or paths or can also be a physical path. For example, the virtual paths can be numbered consecutively so that each path is assigned an identifier or a numerical value. In addition, forward error corrections can also be stored in the frame data.

According to a further aspect of the present invention, the cell format provides a numerical value which identifies a virtual path of a data transmission. This has the advantage that the virtual path can be identified by means of a simple procedure and it can already be determined in the application device which virtual path is to be selected.

According to a further aspect of the present invention, a maximum of 128 virtual paths for data transmission can be set up between the application device and the cell multiplexing device. This has the advantage that virtual paths can be identified on the basis of one byte and, in addition, it would be empirically determined that 128 virtual paths are sufficient in the automobile. In this way, efficient identification of the virtual paths is possible.

According to a further aspect of the present invention, the data transmission device is coupled to a data receiving device which is set up to receive the application data and is also set up to check each forward error correction and wherein, in the event of a negative check of a forward error correction, erroneous application data is replaced by redundantly transmitted application data. This has the advantage that the data receiving device can check the correctness of the data transmission, as all data or application data and/or cells are provided with a forward error correction. Thus, in the case of redundant application data, a first unit of application data can be verified by means of the forward error correction code, i.e. checked for authenticity, and if the forward error correction recognises that the data is not correct, the replacement data, i.e. a unit of second redundantly transmitted application data, can be used. This second application data is also provided with a forward error correction, so that it can also be recognised here whether the data was transmitted correctly.

According to a further aspect of the present invention, the data receiving device has a cell demultiplexing device which forwards application data from the cells to an application device of the data receiving device by means of virtual paths . This has the advantage that an application device is also provided on the receiver side, which corresponds to the application device on the transmitter side and thus the two application devices can communicate with each other. For example, the transmitter device of the receiver device can be designed analogue and thus the received data passes through the same devices in reverse as on the transmitter side. Here, too, it is advantageous to check the data as late as possible, as it is transmitted to the application device on the receiver side together with the forward error correction and it is therefore possible to carry the forward error correction to the end of the processing procedure and recognise any errors.

According to a further aspect of the present invention, each cell is encoded with a forward error correction. This has the advantage that all data is provided with forward error corrections and thus it is not only possible to recognise corresponding errors, but also to correct them. If this is not possible on the receiver side, replacement data is provided in accordance with the invention, which can then also be checked for correctness and can then replace the actual data. This ensures that error-free data is always transmitted and this can also be checked.

According to a further aspect of the present invention, the redundant application data is transmitted between the data transmission device and a data receiving device via separate communication media. This has the advantage that faults in the communication media, for example cables, can also be recognised or rectified. If a communication medium is defective, another communication medium is always available and the replacement data can be sent via this. Thus, there is also fault robustness in the transmission path.

According to a further aspect of the present invention, the application device, the cell multiplexing device and/or the data transmission device are physically designed. This has the advantage of creating a particularly efficient hardware structure that is both error-resistant and performant. This is particularly advantageous in automobiles.

According to a further aspect of the present invention, the multiple of the first number of redundant output interfaces is exactly two. This has the advantage that the data is always transmitted in duplicate and even with a single instance of application data, there are two instances of application data, with one instance corresponding to the actual data and the second instance representing the replacement data.

The task is also solved by a method for securing a data transmission, comprising providing a transmission device set up for redundant encoding of first data units into a first instance of the first data units and a second identical and thus redundant instance of the first data units, and furthermore set up for encoding second data units, whereby a forward error correction is added in each case for all encodings; and a provision of exactly two physical, separate data transmission media which communicatively couple the transmitting device and a receiving device, wherein the transmitting device is arranged to transmit the first instance of the first data units via exclusively one data transmission medium and to transmit the second instance of the first data units via exclusively the respective other data transmission medium and further to transmit the second encoded data units via an optional one of the two data transmission media to the receiving device.

The problem is also solved by a computer program product with control instructions which implement the proposed method or operate the proposed device.

According to the invention, it is particularly advantageous that the method can be used to operate the proposed devices and units. Furthermore, the proposed devices and units are suitable for implementing the method according to the invention. Thus, in each case the device implements structural features which are suitable for carrying out the corresponding method. However, the structural features can also be designed as process steps. The proposed method also provides steps for implementing the function of the structural features. In addition, physical components can also be provided virtually or virtualised.

### BRIEF DESCRIPTION OF THE DRAWINGS

Further advantages, features and details of the invention are apparent from the following description, in which aspects of the invention are described in detail with reference to the drawings. The features mentioned in the claims and in the description may be essential to the invention individually or in any combination. Similarly, the above-mentioned features and those further described here can be used individually or in any combination . Functionally similar or identical parts or components are sometimes provided with the same reference signs. The terms "left", "right", "top" and "bottom" used in the description of the embodiments refer to the drawings in an orientation with a normally legible figure designation or normally legible reference signs. The embodiments shown and described are not to be understood as conclusive, but are of an exemplary nature to explain the invention. The detailed description is for the information of the skilled person, therefore known circuits, structures and methods are not shown or explained in detail in the description so as not to complicate the understanding of the present description. In the figures:

FIG. 1 shows a schematic layered model of an architecture for use in the system arrangement for generating surrogate data according to one aspect of the present invention;

FIG. 2 shows a schematic block diagram of the proposed system arrangement for generating surrogate data according to one aspect of the present invention;

FIG. 3 shows a further schematic block diagram of the proposed system arrangement for generating substitute data according to an aspect of the present invention;

FIG. 4 shows a further schematic block diagram of the proposed system arrangement for generating substitute data according to an aspect of the present invention;

FIG. 5 shows a cell data format according to an aspect of the present invention; and

FIG. 6 shows a schematic flowchart of the proposed method for generating substitute data in the case of negative verification of data to be transmitted in an automotive serial data transmission according to another aspect of the present invention.

### DETAILED DESCRIPTION

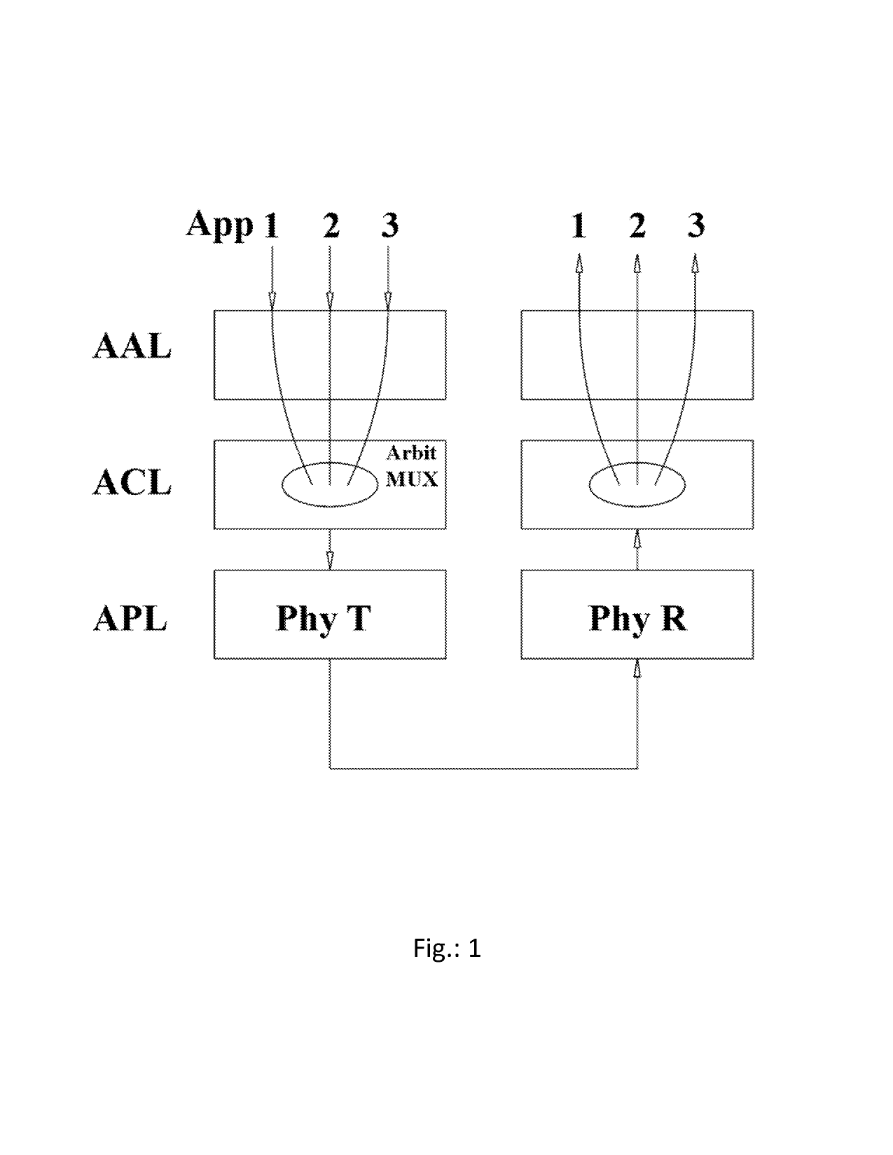

FIG. 1 shows a schematic block diagram of an architecture that can be used according to one aspect of the present invention. For this purpose, three layers are shown twice, which are analogue but inverse and the communication path on the left side runs from the sender downwards to the receiver on the right side upwards. The applications APP 1, 2 and 3, which communicate with the applications on the receiver side, are shown at the top. The application device is shown at the top left, the cell multiplexing device is shown below it and the data transmission device is shown below it on the physical level. This is referred to on the left on the transmitter side as the physical transmitter and on the right side the data receiving device is referred to as the physical receiver.

According to embodiments of the invention, it was recognised that it is precisely in this architecture, i.e. not in a seven-layer architecture, that the data should be multiplied or duplicated between the first two upper layers in a particularly advantageous manner. This ensures that the application data is encoded redundantly at a particularly early stage on the upper layer, i.e. the layer between the application device and the cell multiplexing device. On the receiver side, in this case on the right, the data is also checked or corrected for errors between the cell demultiplexing device and the application device on the top right.

The layers can also be referred to from top to bottom as Application Adaptation Layer AAL (application device), Cell Layer ACL (cell multiplexing device or cell demultiplexing device) and Physical Layer APL (data transmission device).

The Virtual Path Layers are the Physical Layer, which consists of the Transmission Sublayer and the Physical Medium Sublayer, the Cell Layer and the Application Adaptation Layer, which contains the Segmentation & Reassembly Sublayer and the functions for adapting the data formats to the corresponding application.

The main task of the physical layer is to establish the physical connection to other physical layers. This connection should always be understood as bidirectional. Theoretically, this connection can be realised using a wide variety of media. In practice, two serial differential GBps connections are used. In this layer, the line coding, the insertion of empty cells for decoupling the cell rate from the link rate and the integration of the cell stream into the serial frame take place.

In the cell layer, the segmented data (cell payload) from the segmentation and reassembly sub-layer above is assembled into complete cells with header, VP identifier and CRC, or cells are CRC-checked and the payload is forwarded to the segmentation and reassembly sub-layer. This is also where the multiplexing of the various cell streams of the application customisation functions or the distribution of the cell payloads to the application customisation functions according to the VP identifier takes place. (feed-in / feed-out).

Multiplexing and demultiplexing of cell streams in repeaters and splitters (forwarding) also takes place in the Cell Layer.

The task of the application adaptation layer is to adapt the data of the application interfaces to the format of the user data field of the cell and to transmit control information to the remote end or to use control information from the remote end for the adaptation (clock generation, frame construction).

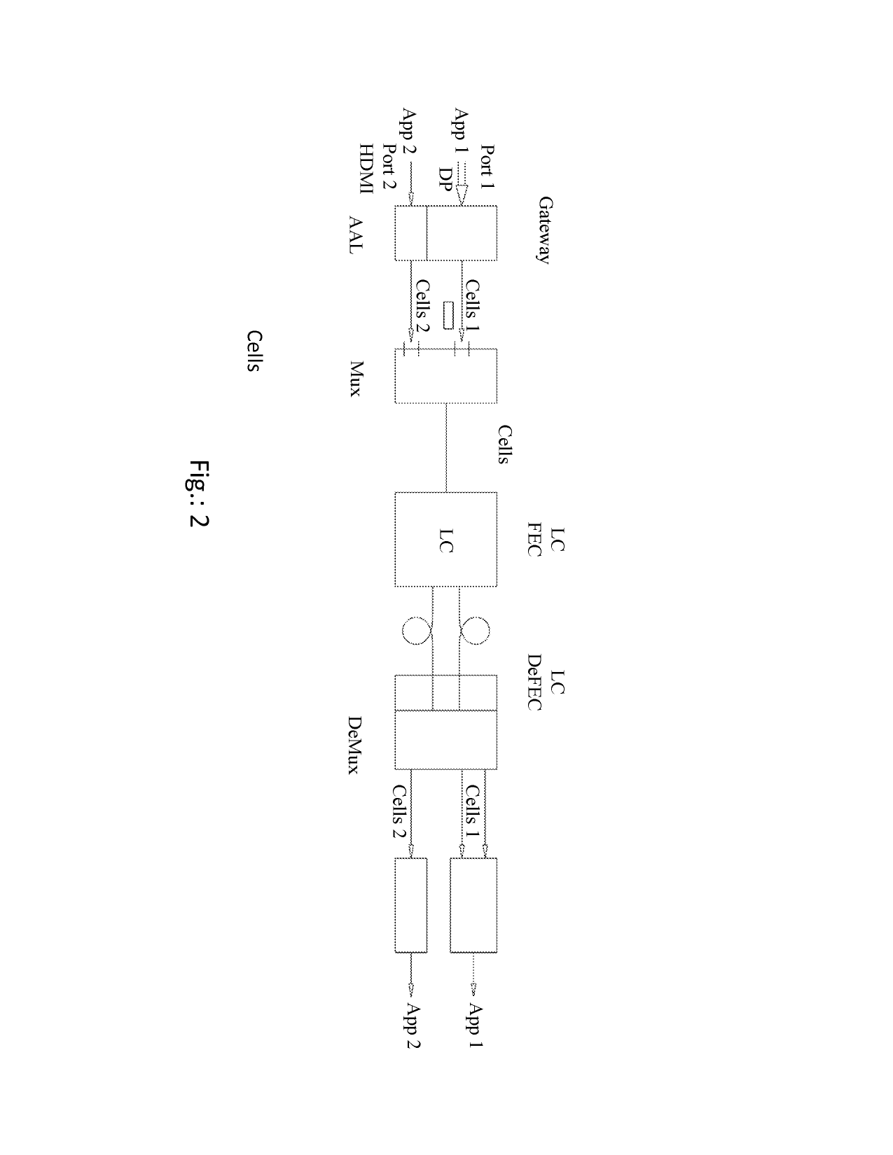

FIG. 2 shows a schematic block diagram of the proposed system arrangement according to one aspect of the present invention. The first three units of the proposed system arrangement are shown on the left-hand side, with the leftmost block representing the application device, the centre block representing the cell multiplexing device and the right-hand block representing the data transmission device. The proposed invention can already be implemented using the first two left-hand blocks, whereby the data is transmitted redundantly between the first and second blocks. Two applications, namely application 1 and application 2, are shown on the left-hand side, each of which transmits data to the application device on the far left by means of an input interface, i.e. a port. The first unit or the application device is designed in such a way that it transmits the data of the first application redundantly and transmits the application data of the second application non-redundantly. This means that the upper arrow of the data transmission between the application device and the cell multiplexing device can also be entered multiple times. Only two paths are shown here, namely the upper path for the redundant data and the lower path for the non-redundant data. As shown on the cell multiplexing device, it can have several input interfaces or data reception interfaces. Cell 1 or cells 1 are therefore transmitted multiple times, while cell 2 or cells 2 are transmitted once. In addition, the cells in the application device are each provided with a forward error correction.

As can be seen in FIG. 2, the data is replicated at an early stage, i.e. already after the first device on the far left. It is therefore particularly advantageous according to the invention that the data is still available here with a high probability of being unaltered. In the third unit, i.e. the data transmission device, the data lines are encoded and/or provided with a forward error correction.

The first three devices thus represent the transmitter and are designed according to the architecture shown in FIG. 1. The loops in the centre of FIG. 2 represent a transmission medium via which the data is transmitted from the transmitter to the receiver on the right-hand side. Only two devices are shown schematically on the right-hand side, but these can also be designed as three devices in the same way as the transmitter. On the far right-hand side, it is shown that the corresponding applications 1 and 2 can utilise the data at the end of processing. According to the redundant transmission, the data is available several times with a forward error correction and thus, for example, the cells 1 can be checked for correctness and the replacement data is used in the event of a negative correctness check.

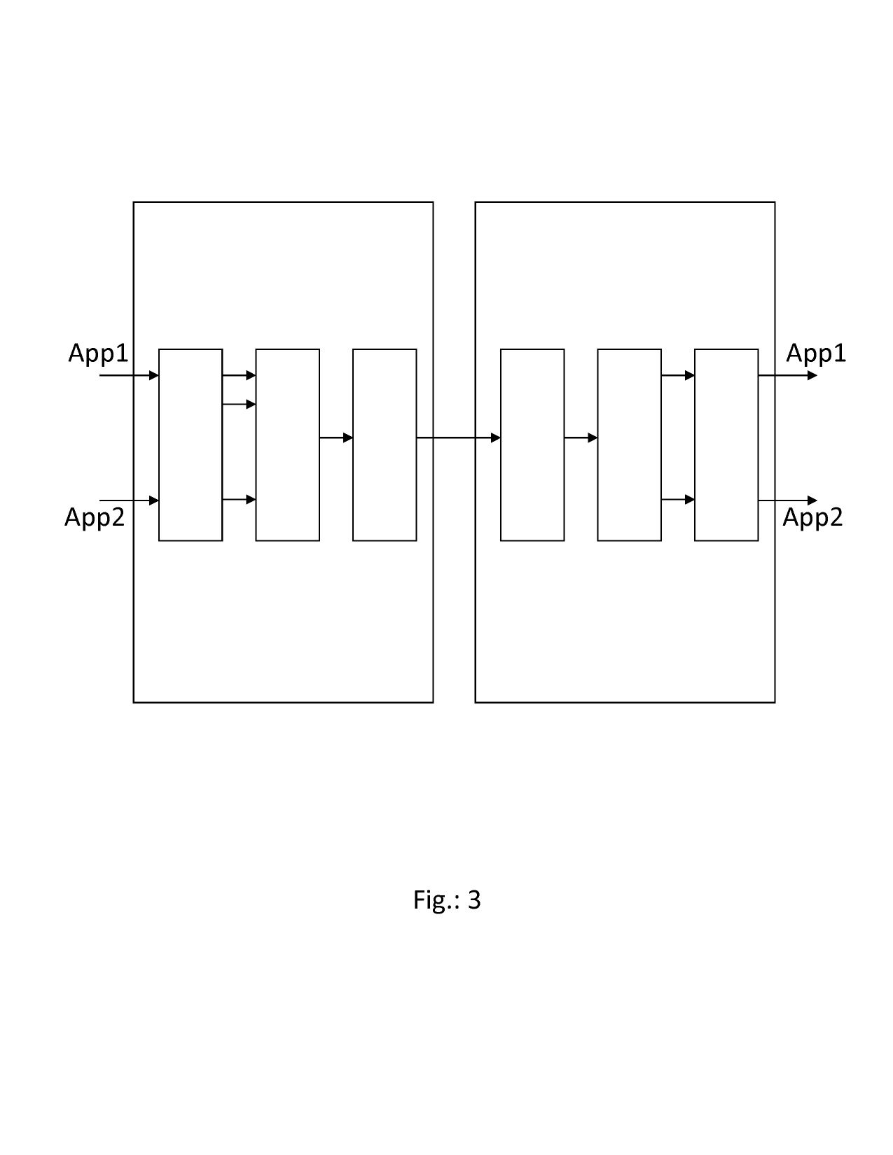

FIG. 3 shows a schematic block diagram of the proposed invention and in particular a system arrangement, whereby the two blocks on the left alone can realise the system arrangement. Further blocks, i.e. blocks 3, 4, 5 and 6 are optional.

As shown here, two applications are provided on the left-hand side, with the first application providing application data that is transmitted redundantly to the cell multiplexing device. This is shown with two arrows. Application 2 supplies non-redundant data, which is therefore transmitted with one arrow. The arrows can be transmission media or at least a contact. Virtual data paths can be implemented here. The sender is shown on the left-hand side and the receiver is shown on the right-hand side, whereby both sides can be implemented analogue but inversely. This means that the application device is shown on the receiver side on the right-hand side, the cell demultiplexing device in the centre and the data receiving device on the left-hand side. The data is transmitted from left to right as shown in and is used by application 1 and application 2 on the right-hand side.

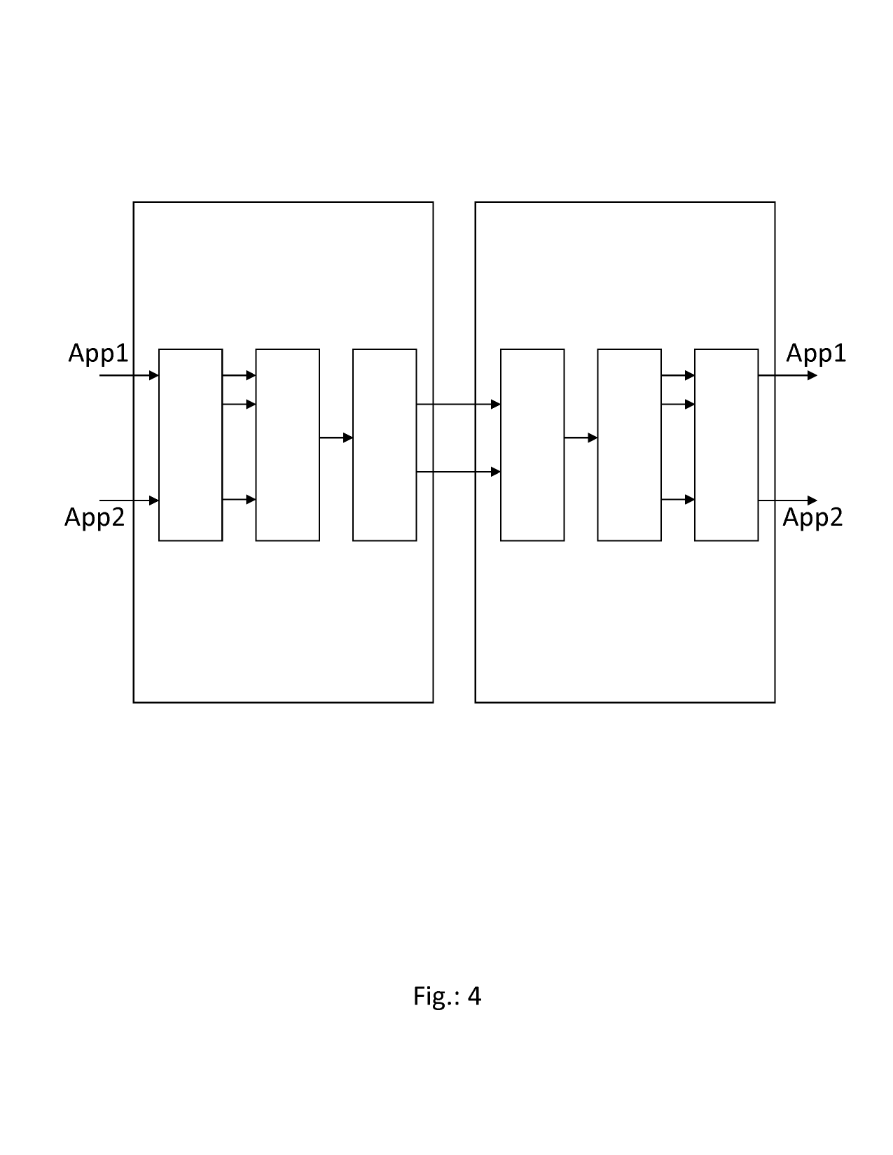

FIG. 4 also shows a schematic overview of the proposed system arrangement, whereby two transmission media are now shown. This means, for example, that the upper transmission medium can transmit the redundant application data and the lower channel, i.e. the lower communication medium, can transmit a redundant instance of this application data. This ensures that the transmission path is also redundant and if a channel is damaged or faulty, the replacement data is transmitted via another channel. The non-redundant application data can optionally be transmitted via one of the channels. It is also possible for different cells of the non-redundant data to be transmitted via different communication media. Thus, according to embodiments of the invention, a redundant data channel is created in a particularly advantageous way, which can be balanced in terms of utilisation.

If, for example, application data is transmitted corruptly or incorrectly, this can be recognised and rectified using the error forward correction. However, if the data is not available because the communication channel fails, the replacement data is used, which is available in any case because the second communication channel is used for this replacement data. In the unlikely event that both communication media fail, the process terminates, which is also recognised. This means that not only is the application data replicated, but it is also transmitted separately via a separate data channel, which further increases error robustness.

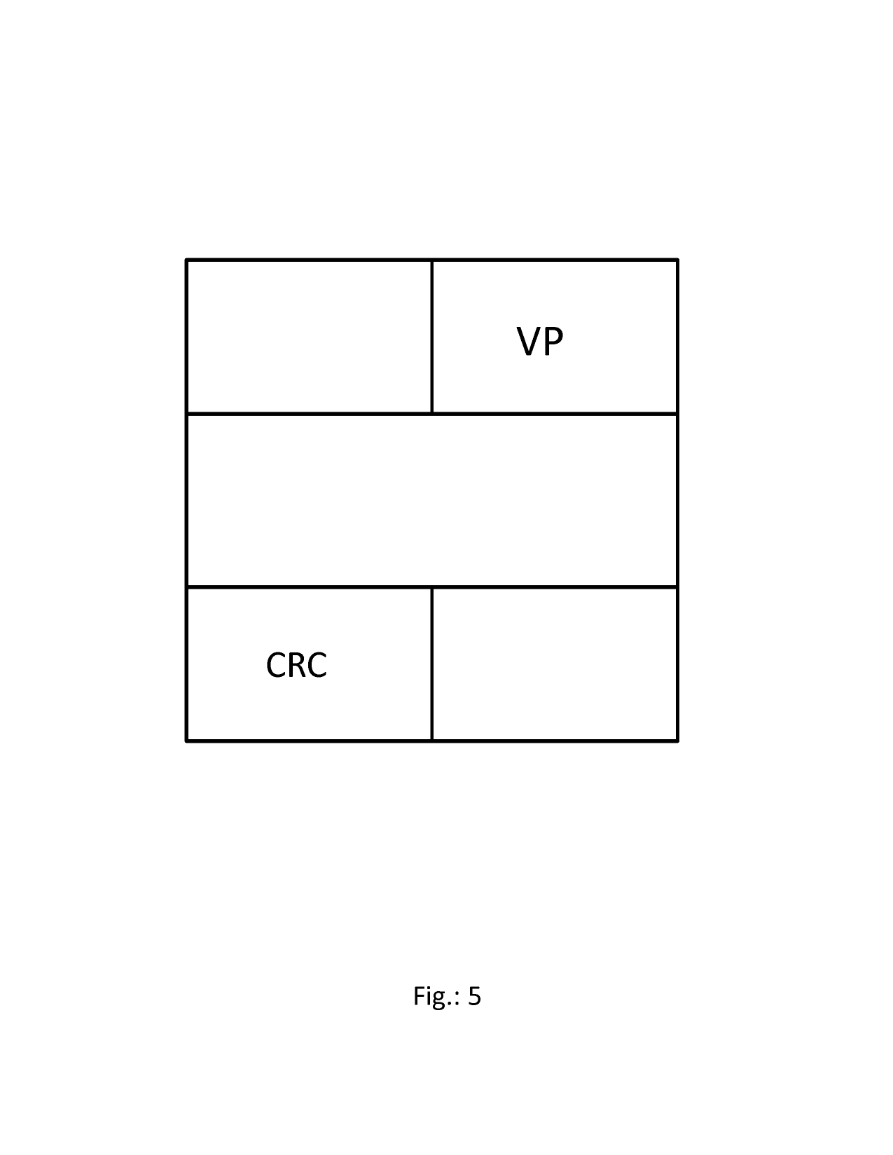

FIG. 5 shows a schematic structure of a target format according to one aspect of the present invention. At the top right, a field is shown which describes a virtual path VP and provides, for example, a numerical value. The numerical value describes the virtual channel via which the cell is to be transmitted. At the bottom left is the abbreviation for a cyclical redundancy check CRC. The other data fields can be additional frame data or the user data, which is preferably transmitted in the largest field. FIG. 5 thus shows an example of a coded cell that contains frame data. The cell is encoded according to the cell format provided. FIG. 5 therefore shows the coded application data, which is coded as a cell format and therefore provides further information in addition to the user data. The virtual path enables redundant data transmission, for example, so that application data packaged in cells can be transmitted via a first virtual path and the same data, i.e. the replacement data, can be transmitted via another virtual path. It is therefore possible for the packaged application data, as shown in FIG. 5, to be available multiple times according to this cell, whereby only the field of the virtual path is adapted.

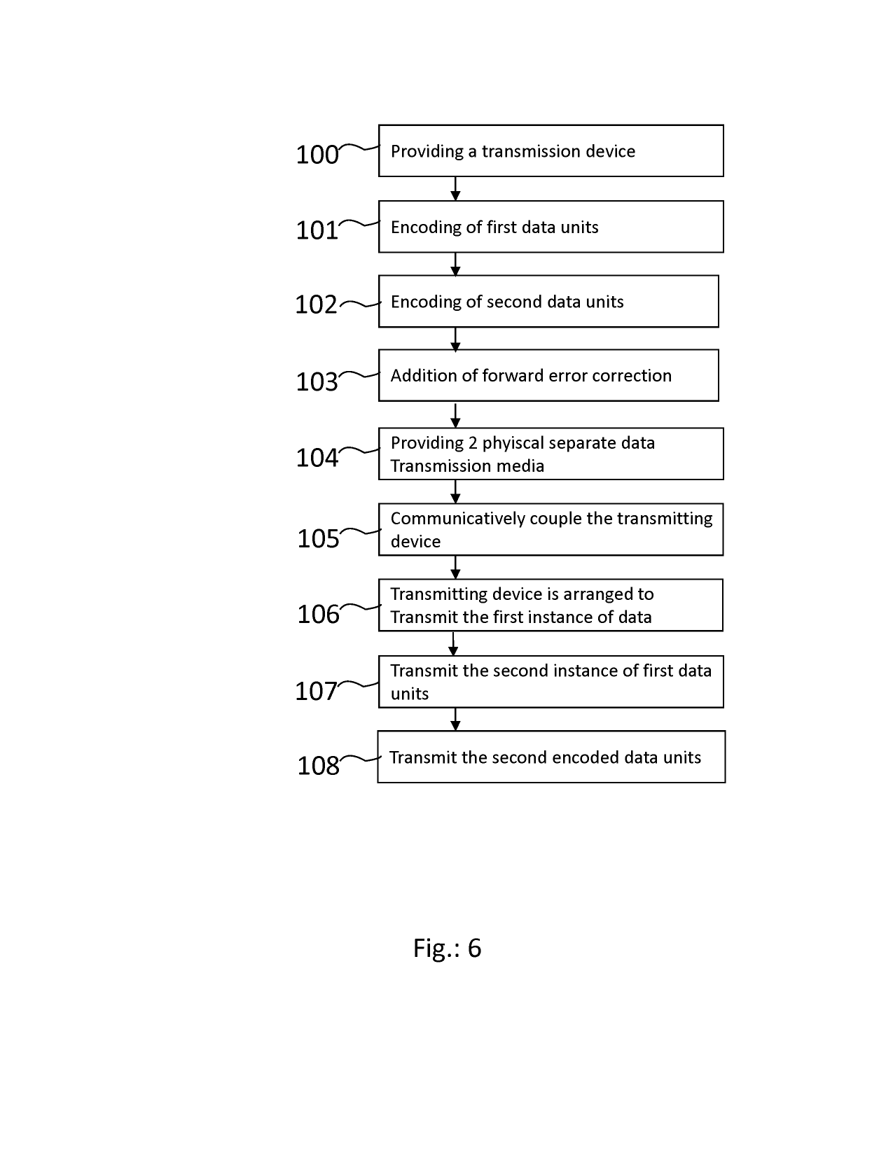

FIG. 6 shows in a schematic flow chart a method for securing a data transmission, comprising a provision 100 of a transmission device set up for redundant encoding 101 of first data units into a first instance of the first data units and a second identical and thus redundant instance of the first data units, and furthermore set up for encoding 102 of second data units, wherein a forward error correction is added 103 in each case for all encodings 101, 102; and providing 104 exactly two physical, separate data transmission media which communicatively couple the transmitting device and a receiving device 105, wherein the transmitting device is arranged to transmit the first instance of the first data units via exclusively one data transmission medium 106 and to transmit the second instance of the first data units via exclusively the respective other data transmission medium 107 and further to transmit the second encoded data units via an optional one of the two data transmission media to the receiving device 108.

Accordingly, a system arrangement for generating substitute data in the event of negative verification of data to be transmitted in a serial data transmission in an automobile is proposed, comprising a physical application device set up for packaging application data in cells of a predefined cell format, wherein the application data is received by means of a first number of input interfaces of the application device and is redundantly output to a cell multiplexing device by means of a multiple of the first number of redundant output interfaces of the application device, and wherein further application data is received by means of a second number of input interfaces of the application device and the second number of non-redundant output interfaces of the application device are output to a cell multiplexing device; and the cell multiplexing device comprising for each output interface of the application device a receiving interface arranged to receive the application data packaged in cells, wherein the cell multiplexing device is arranged to forward the application data packaged in cells to a data transmission device which provides the application data with error forward corrections.

What is claimed is:

1. A system arrangement for securing a data transmission, comprising
a transmission device arranged for redundant encoding of first data units into a first instance of the first data units and a second identical and thus redundant instance of the first data units, and further arranged for encoding second data units, wherein in all encodings a forward error correction is added in each case;
exactly two physical, separate data transmission media which communicatively couple the transmitting device and a receiving device, wherein the transmitting device is arranged to transmit the first instance of the first data units via exclusively one data transmission medium and to transmit the second instance of the first data units via exclusively the respective other data transmission medium and further to transmit the second encoded data units via optionally one of the two data transmission media to the receiving device, and
the receiving device, which is configured to verify the correctness of the first instance of the data units using forward error correction and/ or correct the first instance of the data units, and the receiving device is configured to take the second instance of the data units into account in the event of an incorrect transmission of the first instance of the data units, and the receiving device is configured to take the second instance of the data units into account in the event that the first instance of the data units is not transmitted.

2. The system arrangement of claim 1, wherein the system arrangement is set up for load distribution with respect to bandwidths and/or latency time specifications of the two data transmission media.

3. The system arrangement of claim 1, wherein the transmission of the coded data units via the data transmission media is sequential.

4. The system arrangement of claim 1, wherein the data units are subdivided into cells and a forward error correction is appended to each cell.

5. The system arrangement of claim 1, wherein the coding comprises a line coding.

6. The system arrangement of claim 1, wherein the data transmission can be carried out via virtual paths.

7. The system arrangement of claim 1, wherein the data transmission media are each present in wired form.

8. The system arrangement of claim 1, wherein a specification of transmission parameters together with their tolerance ranges of all data units is implemented cumulatively in the two data transmission media.

9. The system arrangement of claim 1, wherein the data transmission media each support 15 Gbit/s.

10. A method for securing a data transmission, comprising
a provision of a transmission device set up for redundant encoding of first data units into a first instance of the first data units and a second identical and thus redundant instance of the first data units, and further set up for encoding of second data units, wherein in each case a forward error correction is added to all encodings; and
providing exactly two physical, separate data transmission media which communicatively couple the transmitting device and a receiving device, wherein the transmitting device is arranged to transmit the first instance of the first data units via exclusively one data transmission medium and to transmit the second instance of the first data units via exclusively the respective other data transmission medium and further to transmit the second encoded data units via an optional one of the two data transmission media to the receiving device, whereby
the receiving device checks and/or corrects the correctness of the first instance of the data units using forward error correction; and if the first instance of the data units is transmitted incorrectly, the receiving device takes the second instance of the data units into account; and if the first instance of the data units is not transmitted, the receiving device takes the second instance of the data units into account.

11. A non-transitory computer-readable storage medium comprising instructions which, when executed by at least one computer, cause the computer to perform the steps of the method of claim 10.
